(19) United States
(12) Patent Application Publication
(10) Pub. No.: US 2013/0228058 A1
(43) Pub. Date: Sep. 5, 2013

(54) POWER-TOOL PARTING DEVICE

(71) Applicant: ROBERT BOSCH GMBH, Stuttgart (DE)

(72) Inventors: Ivo Gruber, St. Niklaus (CH); Uwe Engelfried, Ostfildern (DE); Petr Grulich, Kirchheim/Teck (DE)

(73) Assignee: Robert Bosch GmbH, Stuttgart (DE)

(21) Appl. No.: 13/781,356

(22) Filed: Feb. 28, 2013

(30) Foreign Application Priority Data
Mar. 2, 2012 (DE) 10 2012 004 051.2

(51) Int. Cl. B23D 53/00

(52) U.S. Cl. CPC B23D 53/00
USPC 83/788

(57) ABSTRACT

A power-tool parting device, in particular a hand power-tool parting device, has at least one cutting strand. The at least one cutting strand includes at least one cutting-strand segment, at least one further cutting-strand segment, and at least one connecting element that is integral with the at least one cutting-strand segment. The at least one connecting element has at least one outside-face fixing surface configured to be fixed to a corresponding fixing surface of the at least one further cutting-strand segment.

This application claims priority under 35 U.S.C. §119 to patent application no. DE 10 2012 004 051.2, filed on Mar. 2, 2012 in Germany, the disclosure of which is incorporated herein by reference in its entirety.

### BACKGROUND

There are already known power-tool parting devices, in particular hand power-tool parting devices, having a cutting strand, which comprises a cutting-strand segment, a further cutting-strand segment and a connecting element that is realized so as to be integral with the cutting-strand segment.

The disclosure is based on a power-tool parting device, in particular a hand power-tool parting device, having at least one cutting strand, which comprises at least one cutting-strand segment, a further cutting-strand segment and at least one connecting element that is realized so as to be integral with the cutting-strand segment.

### SUMMARY

It is proposed that the connecting element has at least one outside-face fixing surface, which is provided for fixing to a corresponding fixing surface of the further cutting-strand segment. A “cutting strand” is to be understood here to mean, in particular, a unit provided to locally undo an atomic coherence of a workpiece that is to be worked, in particular by means of mechanical parting-off and/or by means of mechanical removal of material particles of the workpiece. Preferably, the cutting strand is provided to separate the workpiece into at least two parts that are physically separate from each other, and/or to part-off and/or remove, at least partially, material particles of the workpiece, starting from a surface of the workpiece. Particularly preferably, in at least one operating state the cutting strand is moved in a revolving manner, in particular along a circumferential direction of a guide unit of the power-tool parting device. A “guide unit” is to be understood here to mean, in particular, a unit provided to exert a constraining force upon the cutting strand, at least along a direction perpendicular to a cutting direction of the cutting strand, in order to define a possible motion of the cutting strand along the cutting direction. Preferably, the guide unit has at least one guide element, in particular a guide groove, by which the cutting strand is guided. Preferably, the cutting strand, as viewed in the cutting plane, is guided by the guide unit along an entire circumference of the guide unit by means of the guide element, in particular the guide groove. A “cutting-strand segment” is to be understood here to mean, in particular, a segment of a cutting strand provided to be connected to further segments of the cutting strand for the purpose of constituting the cutting strand. Preferably, the cutting-strand segment and the further cutting-strand segment are realized as a chain link, which is connected to further cutting-strand segments, realized as chain links, for the purpose of constituting the cutting strand, preferably realized as a cutting chain. The cutting-strand segment and the further cutting-strand segment in this case can be realized as a driving member, as a connecting member, as a cutting member, etc. of a cutting chain. The term “connecting element” is intended here to define, in particular, an element provided to positively and/or non-positively join together, in particular to join together in a movable manner, at least two components, in particular chain links of the cutting strand realized as a cutting chain, in order to transmit a driving force and/or a driving torque. In this context, “provided” is to be understood to mean, in particular, specially configured and/or specially equipped.

“Integral with” is to be understood to mean, in particular, formed in one piece, such as, for example, by being produced from a casting and/or by being produced in a single- or multi-component injection process and, advantageously, from a single blank. The term “outside-face fixing surface” is intended here to define, in particular, a surface of the connecting element that, as viewed along a direction extending at least substantially perpendicularly in relation to an outer surface of the cutting-strand segment, is disposed on the connecting element, on a side of the connecting element that faces away from the outer surface. The expression “substantially perpendicularly” is intended here to define, in particular, an alignment of a direction relative to a reference direction, the direction and the relative direction, in particular as viewed in one plane, enclosing an angle of 90° and the angle having a maximum deviation of, in particular, less than 8°, advantageously less than 5°, and particularly advantageously less than 2°. The outside-face fixing surface preferably extends at least substantially parallelwise in relation to the outer surface of the cutting-strand segment. “Substantially parallelwise” is to be understood here to mean, in particular, an alignment of a direction relative to a reference direction, in particular in one plane, the direction deviating from the reference direction by, in particular, less than 8°, advantageously less than 5°, and particularly advantageously less than 2°. It is also conceivable, however, for the outside-face fixing surface to be inclined relative to the outer surface by an angle of more than 8° and less than 90°. In this case, the outside-face fixing surface always faces in a direction that faces away from the outer surface. Preferably the fixing surface of the further cutting-strand segment is of a configuration that corresponds to the outside-face fixing surface. Particularly preferably, the outside-face fixing surface and the fixing surface have a contact plane that extends at least substantially parallelwise in relation to the outer surface. It is also conceivable, however, for the contact plane to be disposed in an inclined manner relative to the outer surface, in dependence on the configuration of the outside-face fixing surface and the fixing surface. Advantageously, by means of the configuration according to the disclosure, the cutting-strand segment and the further cutting-strand segment are easily assembled. Further, advantageously, an easily realized fixing of the cutting-strand segment and of the further cutting-strand segment can be realized. In addition, advantageously, it is possible to achieve a large contact surface for fixing the cutting-strand segment and the further cutting-strand segment to each other. Further, advantageously, when the cutting-strand segment and the further cutting-strand segment have been fixed, it is possible to realize a pivotable mounting of the cutting-strand segment and of the further cutting-strand segment, by means of an outer circumferential surface, in particular a peripheral surface, of the connecting element, extending at least substantially perpendicularly in relation to the outside-face fixing surface.

Furthermore, it is proposed that the outside-face fixing surface, at least in an assembled state, is connected to the fixing surface in a materially bonded manner. In this case, the outside-face fixing surface is preferably connected to the fixing surface in a materially bonded manner, at least when the cutting-strand segment and the further cutting-strand segment are in an assembled state. Preferably, the outside-face fixing surface is connected to the fixing surface in a materially bonded manner by means of a welding method, in particular by means of a resistance spot-welding method. Particularly preferably, the outside-face fixing surface is connected to the fixing surface in a materially bonded manner by means of a laser welding method. It is also conceivable, however, for the outside-face fixing surface to be connected to the fixing surface in a materially bonded manner by means of another method considered appropriate by persons skilled in the art, such as, for example, adhesive bonding, etc. By means of the configuration according to the disclosure, it is possible, advantageously, to achieve a non-separable connection, which can be separated only with the aid of parting tools such as, for example, a saw and/or chemical parting means. Advantageously, therefore, a stable connection can be achieved between the cutting-strand segment and the further cutting-strand segment.

Advantageously, the cutting strand comprises at least one cutting-strand coupling segment, which comprises at least one connecting recess for receiving at least the connecting element. It is also conceivable, however, for the cutting-strand segment and/or the further cutting-strand segment to have a connecting recess, in which a connecting element of the cutting strand can be disposed for the purpose of fixing further cutting-strand segments of the cutting strand and for the purpose of connecting the further cutting-strand segments to the cutting-strand segment and the further cutting-strand segment. Preferably, the cutting-strand coupling segment is realized as a driving member of the cutting strand realized as a cutting chain. The configuration according to the disclosure makes it possible to achieve a positive connection of simple configuration for the purpose of connecting the cutting-strand coupling element to the cutting-strand segment and to the further cutting-strand segment fixed thereto.

Particularly preferably, the connecting element is realized, by tensile forming, so as to be integral with the cutting-strand segment. It is also conceivable, however, for the connecting element to be realized so as to be integral with the cutting-strand segment by means of another method considered appropriate by persons skilled in the art, such as, for example, by means of compression forming, by means of a casting method, etc. Preferably, the connecting element is formed on to the cutting-strand segment by stamping, in particular embossing. Advantageously, a connecting element that can be subjected to high mechanical loading can thus be formed on to the cutting-strand segment.

It is further proposed that the cutting strand has at least one further connecting element, which corresponds to the connecting element and which is realized so as to be integral with the further cutting-strand segment. The further connecting element in this case is preferably realized, by tensile forming, so as to be integral with the further cutting-strand segment. Preferably, the cutting-strand segment and the further cutting-strand segment, when fixed to each other, constitute a chain link of the cutting strand. Advantageously, it is possible to achieve distribution of forces to the cutting-strand segment and to the further cutting-strand segment while the cutting strand is being driven, when the connecting element and the further connecting element are disposed in the connecting recess.

Particularly advantageously, the fixing surface of the further cutting-strand segment is constituted by an outside-face fixing surface of the further connecting element. Advantageously, a large fixing surface can be realized in a fixing region. In addition, advantageously, it is possible to achieve an easily realized fixing of the cutting-strand segment and of the further cutting-strand segment.

It is additionally proposed that the connecting element is realized in the form of a stud. In this case, the connecting element has a circular cross section, as viewed in a plane extending at least substantially parallelwise in relation to a cutting plane of the cutting strand. Particularly preferably, the connecting element is realized in the form of a cylinder. It is also conceivable, however, for the connecting element to be of another configuration, considered appropriate by persons skilled in the art. The term “cutting plane” is intended here to define, in particular, a plane in which the cutting strand, in at least one operating state, is moved, relative to the guide unit, along a circumference of the guide unit, in at least two mutually opposite cutting directions. Preferably, during working of a workpiece, the cutting plane is aligned at least substantially transversely in relation to a workpiece surface that is to be worked. “At least substantially transversely” is to be understood here to mean, in particular, an alignment of a plane and/or of a direction, relative to a further plane and/or a further direction, that preferably deviates from a parallel alignment of the plane and/or of the direction, relative to the further plane and/or the further direction. It is also conceivable, however, for the cutting plane, during working of a workpiece, to be aligned at least substantially parallelwise in relation to a workpiece surface that is to be worked, in particular if the cutting strand is realized as an abrasive. A “cutting direction” is to be understood here to mean, in particular, a direction along which the cutting strand is moved, in at least one operating state, as a result of a driving force and/or a driving torque, in particular in the guide unit, for the purpose of generating a cutting clearance and/or parting-off and/or removing material particles of a workpiece that is to be worked. Preferably, the cutting strand, when in an operating state, is moved, relative to the guide unit, along the cutting direction. The cutting strand and the guide unit together preferably constitute a closed system. By means of the configuration according to the disclosure, it is possible, through simple configuration means, to achieve a connecting element by means of which, advantageously, the cutting-strand segment and the further cutting-strand segment can be mounted in a pivotable manner.

Furthermore, it is proposed that at least the cutting-strand segment has at least one segment guide element, which is provided to limit a movement of the cutting-strand segment, when disposed in a guide unit, as viewed in a direction facing away from the guide unit, at least along a direction extending at least substantially parallelwise in relation to the cutting plane of the cutting strand. Particularly preferably, each cutting-strand segment of the cutting strand of the power-tool parting device has at least one segment guide element, which is provided to limit a movement, when disposed in a guide unit, as viewed in a direction facing away from the guide unit, at least along a direction extending at least substantially parallelwise in relation to the cutting plane of the cutting strand. Preferably, the power-tool parting device has at least one guide unit for receiving the cutting strand, which guide unit comprises at least one segment counter-guide element that corresponds to the segment guide element. It is thereby possible, through simple configuration means, to achieve guidance along a direction of the cutting strand that extends at least substantially parallelwise in relation to a cutting plane of the cutting strand.

Further, the disclosure is based on a portable power tool having a coupling device for positive and/or non-positive coupling to a power-tool parting device according to the disclosure. A “portable power tool” is to be understood here to be, in particular, a power tool for working of workpieces, in particular a hand power tool, that can be transported by an operator without a transport machine. The portable power tool has, in particular, a mass of less than 40 kg, preferably less than 10 kg, and particularly preferably less than 5 kg. Particularly preferably, the cutting strand and the guide unit constitute a closed system. The term “closed system” is intended here to define, in particular, a system comprising at least two components that, by means of combined action, when the system has been demounted from a system such as, for example, a power tool, that is of a higher order than the system, maintain a functionality and/or are inseparably connected to each other when in the demounted state. Preferably, the at least two components of the closed system are connected to each other so as to be at least substantially inseparable by an operator. “At least substantially inseparable” is to be understood here to mean, in particular, a connection of at least two components that can be separated from each other only with the aid of parting tools such as, for example, a saw, in particular a mechanical saw, etc. and/or chemical parting means such as, for example, solvents, etc. By means of the configuration of the power-tool parting device according to the disclosure, it is possible, through simple configuration means, to achieve guidance of the cutting strand. Particularly preferably, the power-tool parting device according to the disclosure and the portable power tool according to the disclosure constitute a power tool system. Advantageously, it is possible to achieve a portable power tool that, particularly advantageously, is suitable for a broad spectrum of applications.

The power-tool parting device according to the disclosure and/or the portable power tool according to the disclosure are not intended in this case to be limited to the application and embodiment described above. In particular, the power-tool parting device according to the disclosure and/or the portable power tool according to the disclosure can have individual elements, components and units that differ in number from the number stated herein, in order to fulfill a principle of function described herein.

### BRIEF DESCRIPTION OF THE DRAWINGS

Further advantages are given by the following description of the drawing. The drawing shows exemplary embodiments of the disclosure. The drawing and the description contain numerous features in combination. Persons skilled in the art will also expediently consider the features individually and combine them to create appropriate further combinations.

In the drawing:

FIG. 1 shows a portable power tool according to the disclosure, having a power-tool parting device according to the disclosure, in a schematic representation,

FIG. 2 shows a detail view of the power-tool parting device according to the disclosure, in a schematic representation,

FIG. 3 shows a detail view of a cutting-strand segment of a cutting strand of the power-tool parting device according to the disclosure, in a schematic representation,

FIG. 4 shows a sectional view of the cutting-strand segment connected to a further cutting-strand segment of the cutting-strand segment, in a schematic representation,

FIG. 5 shows a detail view of an alternative cutting-strand segment, in a schematic representation, and

FIG. 6 shows a sectional view of the alternative cutting-strand segment connected to an alternative further cutting-strand segment of the cutting-strand segment, in a schematic representation.

### DETAILED DESCRIPTION

FIG. 1 shows a portable power tool 36a having a power-tool parting device 10a, which together constitute a power-tool system. The power-tool parting device 10a comprises a cutting strand 12a, which comprises at least one cutting-strand segment 14a, at least one further cutting-strand segment 16a, and at least one connecting element 18a, which is realized so as to be integral with the cutting-strand segment 14a (FIG. 4). Further, the power-tool parting device 10a comprises a guide unit 34a for guiding the cutting strand 12a. The portable power tool 36a has a coupling device 38a for positive and/or non-positive coupling of the power-tool parting device 10a. The coupling device 38a in this case can be realized as a bayonet closure and/or as another coupling device considered appropriate by persons skilled in the art. Further, the portable power tool 36a has a power-tool housing 40a, which encloses a drive unit 42a and a transmission unit 44a of the portable power tool 36a. The drive unit 42a and the transmission unit 44a are operatively connected to each other, in a manner known to persons skilled in the art, for the purpose of generating a driving torque that can be transmitted to the power-tool parting device 10a. The transmission unit 44a is realized as a bevel gear transmission. The drive unit 42a is realized as an electric motor unit. It is also conceivable, however, for the drive unit 42a and/or the transmission unit 44a to be of a different configuration, considered appropriate by persons skilled in the art. The drive unit 42a is provided to drive the cutting strand 12a of the power-tool parting device 10a, at least in one operating state, via the transmission unit 44a. In this case, the cutting strand 12a in the guide unit 34a of the power-tool parting device 10a is moved, in the guide unit 34a, along a cutting direction 46a of the cutting strand 12a.

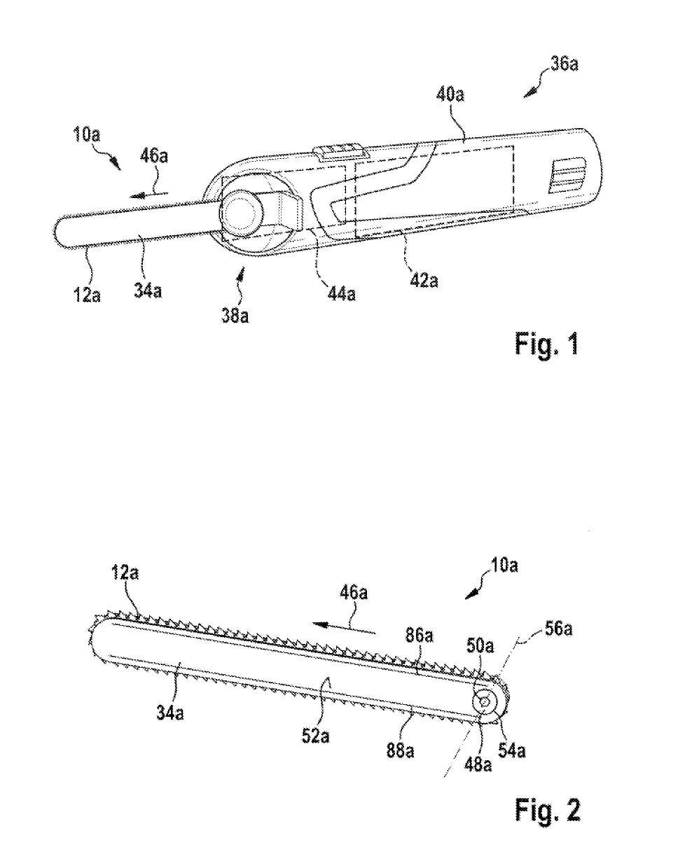

FIG. 2 shows the power-tool parting device 10a decoupled from the coupling device 38a of the portable power tool 36a. The power-tool parting device 10a comprises the cutting strand 12a and the guide unit 34a, which together constitute a closed system. The cutting strand 12a is guided by means of the guide unit 34a. For this purpose, the guide unit 34a has at least one guide element (not represented in greater detail here), realized as a guide groove, by means of which the cutting strand 12a is guided. The cutting strand 12a in this case is guided by means of edge regions of the guide unit 34a that delimit the guide groove. It is also conceivable, however, for the guide element to be realized in a different manner, considered appropriate by persons skilled in the art, such as, for example, as a rib-type device that is formed on the guide unit 34a and engages in a recess on the cutting strand 12a. The cutting strand 12a additionally comprises a multiplicity of cutting-strand segments 14a, 16a, which are connected to each other.

For the purpose of driving the cutting strand 12a, the power-tool parting device 10a or the portable power tool 36a has a torque transmission element 48a, which can be connected to the drive unit 42a and/or to the transmission unit 44a, for the purpose of transmitting forces and/or torques to the cutting strand 12a. In the case of one configuration of the portable power tool 36a comprising the torque transmission element (not represented in greater detail here), the torque transmission element is connected to the cutting strand 12a while the power-tool parting device 10a and the coupling device 38a are coupled. In one configuration of the power-tool parting device 10a comprising the torque transmission element 48a, the torque transmission element 48a and the cutting strand 12a are in engagement even after decoupling from the coupling device 38a. For the purpose of coupling the torque transmission element 48a, realized with the power-tool parting device 10a, and the drive unit 42a and/or the transmission unit 44a, the torque transmission element 48a has a coupling recess 50a, in which, when in an assembled state, there engages a pinion (not represented in greater detail here) of the drive unit 42a and/or a toothed wheel (not represented in greater detail here) and/or a toothed shaft (not represented in greater detail here) of the transmission unit 44a. The coupling recess 50a is disposed concentrically in the torque transmission element 48a. Further, the torque transmission element 48a is realized as a toothed wheel. The torque transmission element 48a is mounted, at least partially, in the guide unit 34a. The torque transmission element 48a in this case, as viewed along a direction perpendicular to the cutting plane, is disposed, at least partially between outer surfaces 52a of the guide unit 34a, in a recess 54a of the guide unit 34a. Further, the torque transmission element 48a is mounted in the guide unit 34a so as to be rotatable about a rotation axis 56a.

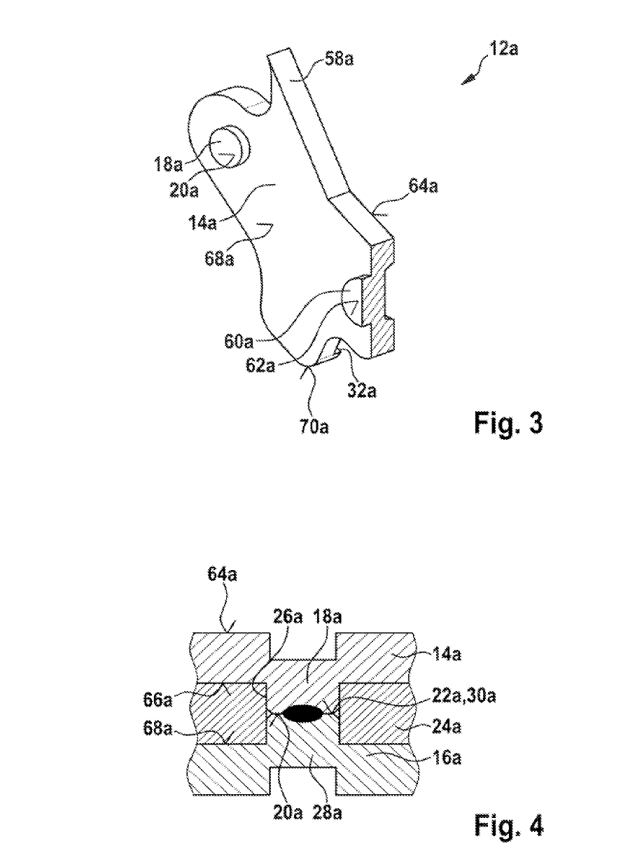

FIG. 3 shows a detail view of the cutting-strand segment 14a. The cutting-strand segment 14a comprises at least one cutting element 58a and the connecting element 18a. It is also conceivable in this case for the further cutting-strand segment 16a, as an alternative or in addition to the cutting-strand segment 14a, to comprise a cutting element. The connecting element 18a is realized in the form of a stud. In this case, the connecting element 18a is cylindrical in form, starting from a lateral inner surface 66a extending at least substantially parallelwise in relation to an outer surface 64a of the cutting-strand segment 14a. In this case, when the cutting-strand segment 14a is fixed to the further cutting-strand segment 16a, the lateral inner surface 66a of the cutting-strand segment 14a faces toward the further cutting-strand segment 16a. The lateral inner surface 66a of the cutting strand 14a faces toward the further cutting-strand segment 16a. The connecting element 18a has at least one outside-face fixing surface 20a, which is provided for fixing to a corresponding fixing surface 22a (FIG. 4) of the further cutting-strand segment 16a. The outside-face fixing surface 20a is constituted by a base surface of the connecting element 18a that extends at least substantially parallelwise in relation to the lateral inner surface 66a of the connecting element 18a. The base surface of the connecting element 18a is realized in the shape of a circle. It is also conceivable, however, for the base surface to have a different shape, considered appropriate by persons skilled in the art, such as, for example, an elliptical shape.

In addition, the cutting-strand segment 14a comprises an additional connecting element 60a. The additional connecting element 60a has at least one additional outside-face fixing surface 62a, which is provided for fixing to a corresponding additional fixing surface (not represented in greater detail here) of the further cutting-strand segment 16a. The additional connecting element 18a in this case is cylindrical in form, starting from the lateral inner surface 66a. In addition, the additional connecting element 60a, as viewed along the cutting direction 46a, is formed on to the cutting-strand segment 14a so as to be offset in an at least substantially parallel manner in relation to the connecting element 18a. The connecting element 18a and the additional connecting element 60a in this case are realized, by tensile forming, so as to be integral with the cutting-strand segment 14a. The connecting element 18a and the additional connecting element 60a are realized, by stamping, so as to be integral with the cutting-strand segment 14a. It is also conceivable, however, for the connecting element 18a and the additional connecting element 60a to be realized so as to be integral with the cutting-strand segment 14a by a different production method, considered appropriate by persons skilled in the art, such as, for example, stretching, drawing, etc.

Furthermore, the cutting strand 12a comprises at least one further connecting element 28a, which corresponds to the connecting element 18a and which is realized so as to be integral with the further cutting-strand segment 16a (FIG. 4). The fixing surface 22a of the further cutting-strand segment 16a is constituted in this case by an outside-face fixing surface 30a of the further connecting element 28a. The further connecting element 28a is likewise realized in the form of a stud. In this case, the further connecting element 28a is likewise cylindrical in form. The outside-face fixing surface 30a of the further connecting element 28a is thus constituted by a base surface of the further connecting element 28a, which base surface extends at least substantially parallelwise in relation to a lateral inner surface 68a of the further cutting-strand segment 16a and, when the further cutting-strand segment 16a is fixed to the cutting-strand segment 14a, faces toward the cutting-strand segment 14a. In this case, the outside-face fixing surface 20a of the connecting element 18a, at least in an assembled state, is connected in a materially bonded manner to the fixing surface 22a of the further cutting-strand segment 16a, realized as an outside-face fixing surface 30a of the further connecting element 28a (FIG. 4). Moreover, the additional outside-face fixing surface 62a of the additional connecting element 60a of the cutting-strand segment 14a, when in an assembled state, is connected in a materially bonded manner to the additional fixing surface (not represented in greater detail here) of the further cutting-strand segment 16a.

Further, the cutting strand 12a has at least one cutting-strand coupling segment 24a, which comprises at least one connecting recess 26a for receiving at least the connecting element 18a (FIG. 4). The cutting-strand coupling segment 24a is realized as a driving member of the cutting strand 12a that, for the purpose of driving, acts in combination with the torque transmission element 48a, in a manner already known to persons skilled in the art. It is also conceivable, however, for cutting-strand coupling segment 24a to be of a different configuration, considered appropriate by persons skilled in the art. When the cutting strand 12a is being assembled, the connecting element 18a of the cutting-strand segment 14a and the further connecting element 28a of the further cutting-strand segment 16a are introduced into the connecting recess 26a from differing sides, until the outside-face fixing surface 20a of the connecting element 18a and the further outside-face fixing surface 30a of the further connecting element 28a bear against each other. The connecting element 18a in this case, starting from the lateral inner surface 66a of the cutting-strand segment 14a in the connecting recess 26a, extends as far as a central plane of the cutting-strand coupling element 24a. The further connecting element 28a likewise, starting from the later inner surface 68a of the further cutting-strand segment 16a in the connecting recess 26a, extends as far as the central plane of the cutting-strand coupling element 24a. The outside-face fixing surface 20a of the connecting element 18a and the further outside-face fixing surface 30a of the further connecting element 28a therefore contact each other in the central plane of the cutting-strand coupling element 24a. It is also conceivable, however, for the connecting element 18a and the further connecting element 28a to contact each other in a plane in the connecting recess 26a that extends at least substantially parallelwise in relation to the central plane of the cutting-strand coupling element 24a. It is therefore conceivable for the connecting element 18a and the further connecting element 28a to be of extents that differ from each other along a at least substantially perpendicular to the respective lateral inner surface 66a, 68a. In this case, the extents should be respectively matched to each other in such a way that at least a distance between the cutting-strand segment 14a and the further cutting-strand segment 16a is bridged. Moreover, it is likewise conceivable for only the cutting-strand segment 14a to have a connecting element 18a having an outside-face fixing surface 20a, and for the fixing surface of the further cutting-strand segment 16a to be constituted by the lateral inner surface 68a of the further cutting-strand segment 16a.

After the connecting element 18a and the further connecting element 28a have been introduced into the connecting recess 26a, the connecting element 18a and the further connecting element 28a are connected to each other in a materially bonded manner by means of spot welding on the outside-face fixing surface 20a of the connecting element 18a and on the further outside-face fixing surface 30a of the further connecting element 28a. As a result of this, the cutting-strand segment 14a and the further cutting-strand segment 16a are fixed to each other. In addition, the cutting-strand segment 14a and the further cutting-strand segment 16a are jointly pivotably mounted, relative to the cutting-strand coupling element 24a, via circumferential surfaces of the connecting element 18a and of the further connecting element 28a. The additional connecting element 60a is introduced into a connecting recess of a further cutting-strand coupling segment (not represented in greater detail here), in a manner similar to the procedure described above, and connected in a materially bonded manner, by the additional outside-face fixing surface 62a, by spot welding, to the additional fixing surface (not represented in greater detail here) of the further cutting-strand segment 16a. This procedure is repeated until the cutting strand 12a has attained a desired length and is thus realized as a cutting chain. The cutting-strand segment 14a and the further cutting-strand segment 16a, when fixed to each other, constitute a cutting member of the cutting strand 12a realized as a cutting chain.

The cutting-strand segment 14a furthermore has at least one segment guide element 32a, which is provided to limit a movement of the cutting-strand segment 14a and of the further cutting-strand segment 16a, when disposed in a guide unit 34a, as viewed in a direction facing away from the guide unit 34a, at least along a direction extending at least substantially parallelwise in relation to the cutting plane of the cutting strand 12a. The segment guide element 32a is constituted by a transverse extension, which extends at least substantially perpendicularly in relation to the outer surface 64a of the cutting-strand segment 14a. The segment guide element 32a is provided to act in combination with segment counter-guide elements 86a, 88a (FIG. 2) of the guide unit 34a, which are disposed on an inner surface of the guide unit 34a that faces toward the cutting-strand segment 14a, for the purpose of limiting movement. The segment counter-guide elements 86a, 88a are realized so as to correspond to the segment guide element 32a of the cutting-strand segment 14a. The further cutting-strand segment 16a can likewise have a segment guide element.

In addition, the cutting-strand segment 14a has a compressive-force transmission surface 70a. The compressive-force transmission surface 70a is provided, by acting in combination with a compressive-force absorbing region (not represented in greater detail here) of the guide unit 34a, to support compressive forces that act upon the cutting strand 12a when a workpiece (not represented in greater detail here) is being worked. The compressive-force absorbing region of the guide unit 34a in this case, as viewed along a direction extending at least substantially perpendicularly in relation to the cutting plane of the cutting strand 12a, is disposed between the two outer surfaces 52a of the guide unit 34a that extend at least substantially parallelwise in relation to each other. In this case, each cutting-strand segment of the cutting strand 12 comprises a compressive-force transmission surface.

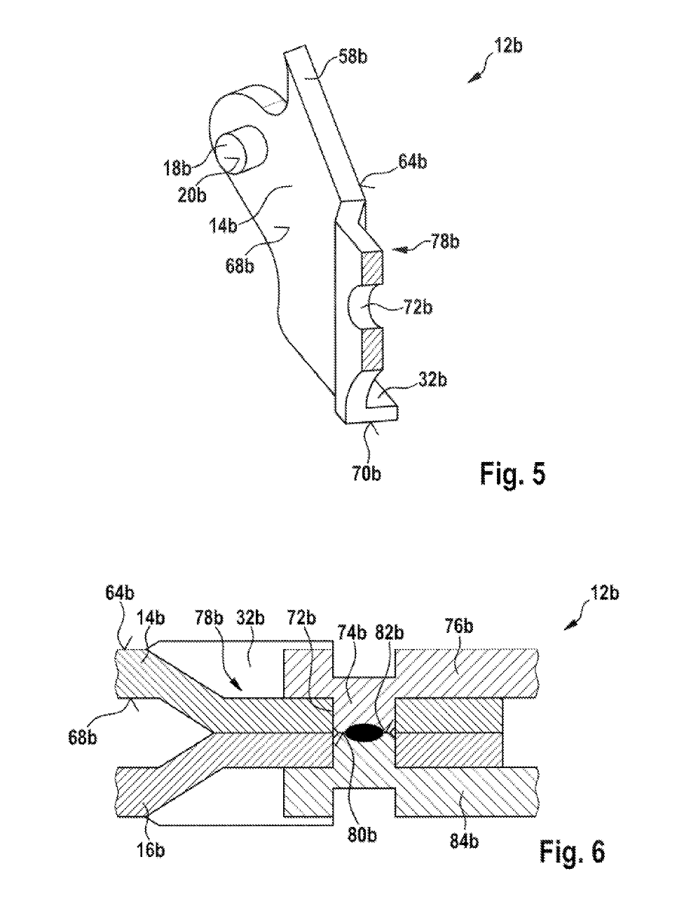

An alternative exemplary embodiment is represented in FIGS. 5 and 6. Components, features and functions that remain substantially the same are denoted, basically, by the same references. The description that follows is limited substantially to the differences in relation to the first exemplary embodiment, described in FIGS. 1 to 4, and reference may be made to the description of the first exemplary embodiment in FIGS. 1 to 4 in respect of components, features and functions that remain the same.

FIG. 5 shows a detail view of an alternative cutting-strand segment 14b of an alternative cutting strand 12b. The cutting-strand segment 14b has a connecting element 18b of the cutting strand 12b that is realized so as to be integral with the cutting-strand segment 14b. The connecting element 18b is realized in a manner similar to the connecting element 18a from FIGS. 3 and 4. The connecting element 18b thus has at least one outside-face fixing surface 20b, which is provided for fixing to a corresponding fixing surface (not represented in greater detail here) of a further cutting-strand segment 14b (FIG. 6). In addition, the cutting-strand segment 14b has a connecting recess 72b, which is provided, when the cutting strand 12b is in the assembled state, to receive at least one additional connecting element 74b of an additional cutting-strand segment 76b of the cutting strand 12b (FIG. 6), which additional connecting element is realized in a manner similar to the connecting element 18b. For this purpose, the connecting recess 72b has a circular cross section. The connecting recess 72b in this case is made in the cutting-strand segment 14b by means of a punching method. It is also conceivable, however, for the connecting recess 72b to be made in the cutting-strand segment 14b by means of a different method, considered appropriate by persons skilled in the art, such as, for example, by means of drilling, turning, etc. The connecting recess 72b is disposed in a connecting region 78b of the cutting-strand segment 14b that is offset at least substantially parallelwise relative to an outer surface 64b of the cutting-strand segment 14b and relative to a lateral inner surface 68b of the cutting-strand segment 14b. By means of an angled partial region of the cutting-strand segment 14b, the connecting region 78b is disposed in an offset manner relative to the outer surface 64b and the lateral inner surface 68b. In this case, a lateral surface of the connecting region 78b is disposed, together with the outside-face fixing surface 20b, in a plane extending parallelwise in relation to an outer surface 64b of the cutting-strand segment 14b.

When the cutting strand 12b is being assembled, the additional connecting element 74b of the additional cutting-strand segment 76b is introduced into the connecting recess 72b from one side. A connecting element (not represented in greater detail here) of a further, additional cutting-strand segment (not represented in greater detail here) of the cutting strand 12b is then likewise introduced into a connecting recess (not represented in greater detail here) of the additional cutting-strand segment 76b. This procedure is continued until the cutting strand 12b has attained a desired length and constitutes a closed loop. Therefore, when the cutting-strand segment 14b is in a closed loop, the connecting element 18b is disposed in a connecting recess (not represented in greater detail here) of one of a multiplicity of further, additional cutting-strand segments (not represented in greater detail here) of the cutting strand 12b. The cutting-strand segment 14b, together with the additional cutting-strand segment 76b and the multiplicity of further, additional cutting-strand segments (not represented in greater detail here) of the cutting strand 12b, as viewed along a cutting plane of the fully assembled cutting strand 12b, constitutes one cutting-strand half.

The procedure described above is performed in a similar manner in the case of the further cutting-strand segment 16b. The further cutting-strand segment 16b, together with a multiplicity of further, additional cutting-strand segments (not represented in greater detail here) of the cutting strand 12b, as viewed along a cutting plane of the fully assembled cutting strand 12b, constitutes one further cutting-strand half. The cutting-strand half and the further cutting-strand half are then joined to each other in the cutting plane. In this case, an outside-face fixing surface 80b of the additional connecting element 74b is connected in a materially bonded manner to a corresponding fixing surface 82b of a corresponding cutting-strand segment 14b of the cutting strand 12b, by means of spot welding (FIG. 6). The outside-face fixing surface 20b of the connecting element 18b of the cutting-strand segment 14b in this case is likewise connected in a materially bonded manner, by means of spot welding, as has already been described analogously in FIGS. 1 to 4, to the corresponding fixing surface (not represented in greater detail here) of the further cutting-strand segment 14b. The cutting strand 12b is fully assembled after all outside-face fixing surfaces have been connected in a materially bonded manner to the corresponding fixing surfaces. For the purpose of constituting a power-tool parting device, not represented in greater detail here, that is at least substantially similar to the power-tool parting device 10a, the cutting strand 12b is inserted in a guide-unit main element (not represented in greater detail here) of a guide unit (not represented in greater detail here). For the purpose of constituting the guide unit, the guide-unit main element is then connected by means of at least one further guide-unit main element (not represented in greater detail here) of the guide unit, which is fixed to the guide-unit main element. The guide unit and the cutting strand 12b thus constitute a closed system.

What is claimed is:

1. A power-tool parting device, comprising:
at least one cutting strand, including:
at least one cutting-strand segment,
at least one further cutting-strand segment, and
at least one connecting element that is integral with the at least one cutting-strand segment, wherein the at least one connecting element has at least one outside-face fixing surface configured to be fixed to a corresponding fixing surface of the at least one further cutting-strand segment.

2. The power-tool parting device according to claim 1, wherein the at least one outside-face fixing surface, at least in an assembled state, is connected to the corresponding fixing surface in a materially bonded manner.

3. The power-tool parting device according to claim 1, wherein the at least one cutting strand includes at least one cutting-strand coupling segment including at least one connecting recess configured to receive at least the at least one connecting element.

4. The power-tool parting device according to claim 1, wherein the at least one connecting element is tensile formed so as to be integral with the at least one cutting-strand segment.

5. The power-tool parting device according to claim 1, wherein the at least one cutting strand has at least one further connecting element which corresponds to the at least one connecting element and which is integral with the at least one further cutting-strand segment.

6. The power-tool parting device according to claim 5, wherein the corresponding fixing surface of the at least one further cutting-strand segment is an outside-face fixing surface of the at least one further connecting element.

7. The power-tool parting device according to claim 1, wherein the at least one connecting element is a stud.

8. The power-tool parting device according to claim 1, wherein at least the at least one cutting-strand segment has at least one segment guide element configured to limit a movement of the at least one cutting-strand segment, when disposed in a guide unit, as viewed in a direction facing away from the guide unit, at least along a direction extending at least substantially parallelwise in relation to a cutting plane of the at least one cutting strand.

9. A portable power tool comprising:
a coupling device configured to couple to a power-tool parting device via at least one of positive coupling and non-positive coupling, wherein the power-tool parting device includes:
at least one cutting strand, including:
at least one cutting-strand segment,
at least one further cutting-strand segment, and
at least one connecting element that is integral with the at least one cutting-strand segment, wherein the at least one connecting element has at least one outside-face fixing surface configured to be fixed to a corresponding fixing surface of the at least one further cutting-strand segment.

10. A power-tool system comprising:
a portable power tool including:
a coupling device configured to couple to at least one power-tool parting device via at least one of positive coupling and non-positive coupling, wherein the at least one power-tool parting device includes:
at least one cutting strand, including:
at least one cutting-strand segment,
at least one further cutting-strand segment, and
at least one connecting element that is integral with the at least one cutting-strand segment, wherein the at least one connecting element has at least one outside-face fixing surface configured to be fixed to a corresponding fixing surface of the at least one further cutting-strand segment.
